(19) United States
(12) Patent Application Publication
(10) Pub. No.: US 2026/0166584 A1
(43) Pub. Date: Jun. 18, 2026

(54) COLLOID DISPENSING SYSTEM, A COLLOID DISPENSING METHOD, AND A METHOD FOR ESTABLISHING ITS COLLOID PHYSICAL MODEL

(71) Applicant: Delta Electronics, Inc., Taoyuan City (TW)

(72) Inventors: Yu-Cheng SU, Taoyuan City (TW); Yu-Wei YEH, Taoyuan City (TW); Shao-Huang LU, Taoyuan City (TW); Ju-Hsin KUNG, Taoyuan City (TW)

(21) Appl. No.: 19/202,247

(22) Filed: May 8, 2025

(30) Foreign Application Priority Data
Dec. 18, 2024 (CN) 202411873576.9

(51) Int. Cl. B05C 11/10; G05B 17/02

(52) U.S. Cl. CPC B05C 11/10; G05B 17/02

(57) ABSTRACT

A colloid dispensing system is provided. The colloid dispensing system includes a computer device. The computer device includes a colloid dispensing parameter-setting module and a dispensing simulation module. The colloid dispensing parameter-setting module is configured to set at least one colloid dispensing parameter. The dispensing simulation module is configured to perform a colloid physical simulation based on the colloid dispensing parameter to generate a digital twin of a dispensing result. The colloid physical simulation is based on a Navier-Stokes equation, a surface tension physical model, or both.

### CROSS REFERENCE TO RELATED APPLICATIONS

This application claims priority of China Patent Application No. 202411873576.9, filed on Dec. 18, 2024, the entirety of which is incorporated by reference herein.

### BACKGROUND OF THE INVENTION

### Field of the Invention

The present invention relates to a colloid dispensing system, and in particular it relates to a colloid dispensing system based on digital twins.

### Description of the Related Art

Dispensing operations play an important role in electronic manufacturing, with applications including solder paste dispensing, sealant dispensing, grease dispensing, thermal paste dispensing, and encapsulation of printed circuits, among others. Traditional dispensing machines utilize robotic arms or X-Y (-Z) positioning stages combined with dispensing valves to achieve automated dispensing. However, existing colloid dispensing systems and methods have several drawbacks, which mainly manifest in the following aspects.

(1) Path planning: Current path planning methods mainly rely on the manual setting of dispensing points and adjusting the spacing between points based on experience. This approach is inefficient and prone to errors.

(2) Parameter setting: The parameter settings for dispensing machine, such as moving speed, dispensing speed, and dispensing valve height, typically require adjustments based on manual experience and lack scientific foundations.

(3) Dispensing result detection: The detection of dispensing results largely relies on manual visual inspection or existing Automated Optical Inspection (AOI) equipment. However, these methods are inefficient, costly, and require extensive data collection and training for different dispensing forms.

(4) Parameter optimization: Existing parameter optimization methods mainly depend on manual experience and lack effective automation optimization techniques, which makes it difficult to improve dispensing quality.

The above-mentioned draw backs primarily arise from the following reasons: The various parameters of the dispensing machine affect the width and height of the applied dispensing, which in turn impacts the dispensing quality. However, the complex relationships between parameters are difficult to quantify, and currently, judgment and adjustments mainly rely on manual experience. Additionally, the different stages of the dispensing process are relatively independent, lacking effective integration and utilization of information. For example, existing dispensing result detection methods often do not take into account the information obtained during path planning, leading to reduced detection efficiency and accuracy.

To address the above issues, a colloid dispensing system is needed that can simplify path planning, defect detection, and parameter optimization.

### BRIEF SUMMARY OF THE INVENTION

An embodiment of the present invention provides a colloid dispensing system, including: a computer device, which includes a colloid dispensing parameter-setting module and a dispensing simulation module. The colloid dispensing parameter-setting module is configured to set at least one colloid dispensing parameter. The dispensing simulation module performs a colloid physical simulation based on the colloid dispensing parameters to generate a digital twin of the experimental (real-wrold) dispensing result. The colloid physical simulation is based on Navier-Stokes equations, a surface tension physical model, or both.

In an embodiment of the present invention, the colloid dispensing parameters include one or more of the following: viscosity coefficient, surface tension coefficient, moving speed, dispensing speed, dispensing valve height, colloid height, and colloid width.

In an embodiment of the present invention, the colloid dispensing system further comprises a colloid dispensing device configured to perform experimental dispensing based on the colloid dispensing parameters to generate an experimental colloid.

In an embodiment of the present invention, the colloid dispensing system further comprises an imaging device configured to capture an image of the experimental colloid and transmit the image to the computer device; wherein the computer device further includes a comparison module which compares the measured results of the experimental colloid with the simulated dispensing results and detects whether there are abnormal results. If an abnormal result is detected, the colloid dispensing parameter-setting module adjusts the colloid dispensing parameters accordingly.

In an embodiment of the present invention, the comparison module compares the image of the experimental colloid with the simulated dispensing results, detects the discrepancy between the image of the experimental colloid and the simulated dispensing results, and modifies the colloid physical simulation model based on the discrepancy to adjust the simulated dispensing results, ensuring that the simulated dispensing results generated by the colloid physical simulation are closer to the measured results of the experimental colloid.

In an embodiment of the present invention, the computer device further comprises a path-planning module, configured to plan a dispensing path based on the colloid dispensing parameters; wherein the planning of the dispensing path is based on one or more of the following: colloid width, colloid height, and colloid radius in the simulated dispensing results.

In an embodiment of the present invention, the colloid dispensing device includes a robotic arm or a positioning stage, configured to carry a dispensing valve system.

In an embodiment of the present invention, the imaging device is a 2D camera or a 3D camera, configured to capture the image of the experimental colloid.

In addition, an embodiment of the present invention provides a colloid dispensing method comprising a colloid dispensing parameter-setting step and a simulated dispensing step. The colloid dispensing parameter involves setting at least one colloid dispensing parameter, and the simulated dispensing step performs a colloid physical simulation based on the colloid dispensing parameters to generate a digital twin of the experimental (real-world) dispensing results. The colloid physical simulation is based on Navier-Stokes equations, a surface tension physical model, or both.

### BRIEF DESCRIPTION OF THE DRAWINGS

FIG. 1 is a flowchart of a colloid dispensing method for colloid dispensing spray, according to an embodiment of the present invention;

FIG. 2 is a schematic diagram of one dispensing result described in an embodiment of the present disclosure, where (a) is a schematic diagram of the actual colloid width W, (b) is a schematic diagram of the actual colloid height H, and (c) is a schematic diagram of the dispensing result;

FIG. 3 is a flowchart for determining colloid dispensing parameters, according to an embodiment of the present invention;

FIG. 4 is a schematic diagram illustrating the actual optimization results according to the disclosed embodiment; and

FIG. 5 is a block diagram of the colloid dispensing system for dispensing according to the disclosed embodiment.

### DETAILED DESCRIPTION OF THE INVENTION

The present invention is described with reference to the accompanying drawings, in which identical reference numerals are used to indicate similar or identical components. The drawings are not to scale and are provided solely for the purpose of explaining the invention. Several embodiments of the invention are described below as illustrated application references. This means that many specific details, relationships, and methods are outlined to provide a comprehensive understanding of the invention. However, it will be recognized by those skilled in the related field that the invention can still be implemented without one or more of the specific details or by other methods.

In other examples, well-known structures or operations are not listed in detail to avoid confusion with the invention. The present invention is not limited by the order of actions or events described, as some actions may occur in a different sequence or simultaneously with other actions or events. Furthermore, not all of the described actions or events need to be performed in the same manner as the existing invention.

The digital twin-based colloid dispensing system and method disclosed herein solve the drawbacks of existing technologies that rely on manual experience and trial-and-error by using a colloid physical simulation. It achieves automation and intelligence in colloid dispensing parameter setting, dispensing result detection, and parameter optimization.

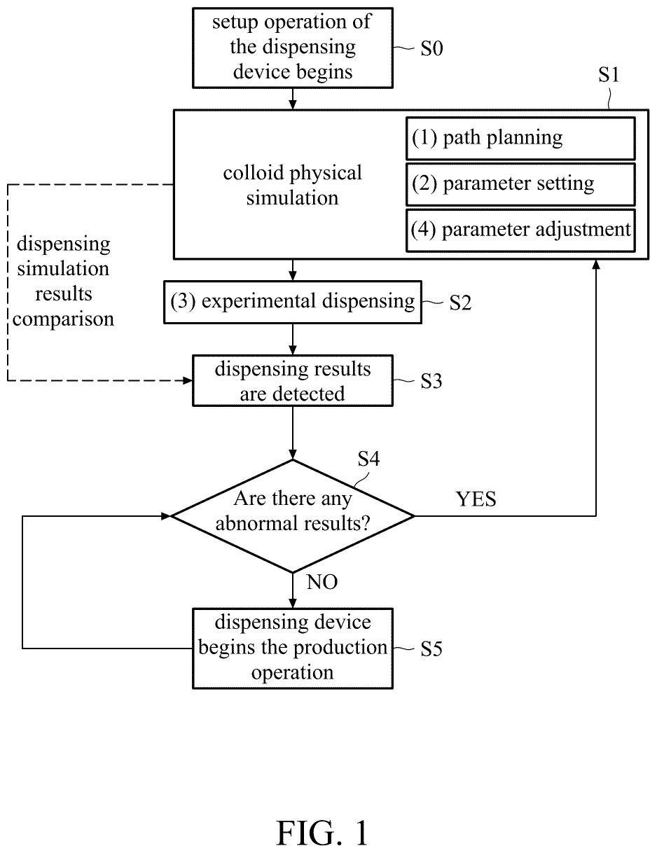

FIG. 1 is a flowchart of a colloid dispensing method for colloid dispensing spray described in an embodiment of the present invention.

The present disclosure utilizes digital twin technology of colloids to map the real-world colloid dispensing process into a virtual simulation environment, in order to achieve automation and intelligence in colloid dispensing parameter setting, dispensing result detection, and parameter optimization.

Specifically, the colloid physical simulation program in the computer device can simulate the dispensing behavior of colloids under different parameters based on fluid dynamics, such as using the Navier-Stokes equations and surface tension physical models, but is not limited to these.

In one embodiment, by adjusting simulation parameters such as viscosity coefficient, surface tension coefficient, dispensing speed, dispensing valve height, moving speed, colloid height, colloid width, etc., different simulated dispensing results can be obtained, such as the height, width, shape of the colloid, and whether defects occur. These simulation results can quantify the dispensing quality and serve as the basis for optimizing the colloid dispensing parameters.

In one embodiment, to ensure the accuracy and reliability of the colloid physical simulation results, key simulation parameters of the colloid, such as viscosity coefficient and surface tension coefficient, need to be obtained.

In one embodiment, using experimental data and colloid physical simulation technology, the process for establishing the digital twin of the colloid dispensing process and comparing the simulation results is as follows.

First, in step S0, the setup operation of the colloid dispensing device begins. The setup operation is carried out based on the physical simulation model of the colloid.

In one embodiment, the physical simulation model of the colloid is established based on the material characteristics of the colloid. For example, it may be created using the Navier-Stokes equations in fluid dynamics and a surface tension model to describe the flow and deformation behavior of the colloid. The equations of this fluid model can be solved using methods such as particle methods or grid methods, but are not limited to these. For instance, any method capable of solving the equations, provided the viscosity coefficient and surface tension coefficient are predetermined, can be used.

In step S1, during the process of colloid physical simulation, the following steps are performed: (1) path planning: Based on colloid dispensing parameters, such as colloid width, colloid height, and colloid radius, at least one of these parameters is used to plan the dispensing path, ensuring that the colloid evenly covers the target area.

Then, (2) parameter setting: Based on the simulation results and the predetermined dispensing quality requirements, the operational parameters of the colloid dispensing device are set through simulation combined with optimization algorithms. These parameters include, but are not limited to, moving speed, dispensing speed, dispensing valve height, viscosity coefficient, and surface tension coefficient.

In one embodiment, each colloid dispensing parameter may be an initial value entered in advance, or it may be an actual measured value obtained through experiments, or a simulated value obtained through simulation calculations, but is not limited to these.

Next, proceed to step S2, where experimental dispensing is performed, and then proceed to step S3.

In step S3, the experimental dispensing results are detected. The images of the experimental dispensing results are compared with the simulation results, and any dispensing defects or abnormal results are detected, such as insufficient dispensing, excess dispensing, or overflow.

Proceed to step S4, where it is determined whether there are abnormal results. If the result is yes, meaning there is an abnormality in the actual dispensing result, return to step S1 to perform (4) parameter adjustment. For example, the viscosity coefficient, surface tension coefficient, dispensing speed, dispensing valve height, moving speed, etc., can be adjusted to obtain different simulated dispensing results.

In one embodiment, when reviewing the dispensing results, the actual dispensing results can also be compared with the simulated dispensing results as a reference for fine-tuning the model parameters, correcting the discrepancy between the actual and simulated dispensing results, but this is not limited to this.

In step S4, when determining whether there are abnormal results, if the result is no, meaning there is no abnormality in the actual dispensing results, proceed to step S5.

In step S5, the colloid dispensing device begins the production operation, for example, making the colloid dispensing device complete the dispensing process based on the planned dispensing path and colloid dispensing parameters.

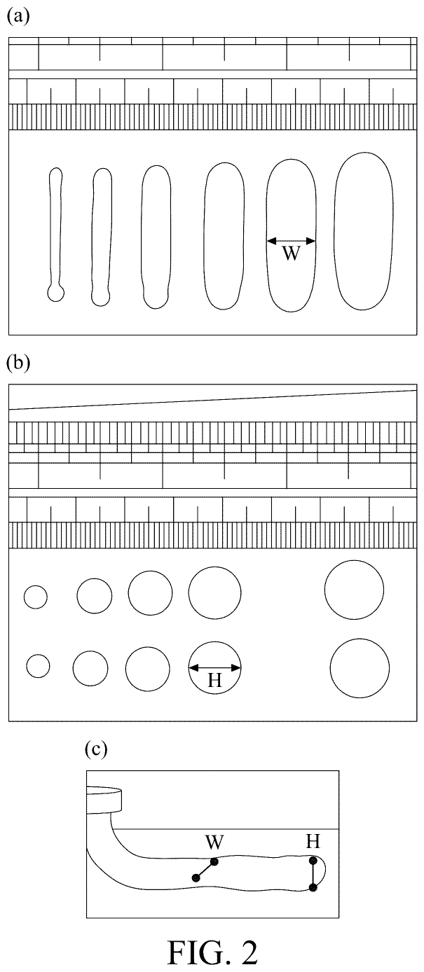

FIG. 2 is a schematic diagram of one dispensing result described in an embodiment of the present disclosure, where (a) is a schematic diagram of the actual colloid width W, (b) is a schematic diagram of the actual colloid height H, and (c) is a schematic diagram of the dispensing result.

In one embodiment, there may be cases where the colloid used, such as commercially available colloids, does not provide information on the viscosity coefficient and surface tension coefficient. In such cases, the following experimental process can be used to determine the values of the viscosity coefficient and surface tension coefficient that can be used in the simulation.

Specifically, by comparing the simulation results of the colloid with the actual colloid width or height obtained from experiments, as shown in FIG. 2, the model can be fine-tuned and corrected to produce simulation results that closely match the actual colloid. Based on these results, the values of the viscosity coefficient and surface tension coefficient used in the simulation can be derived.

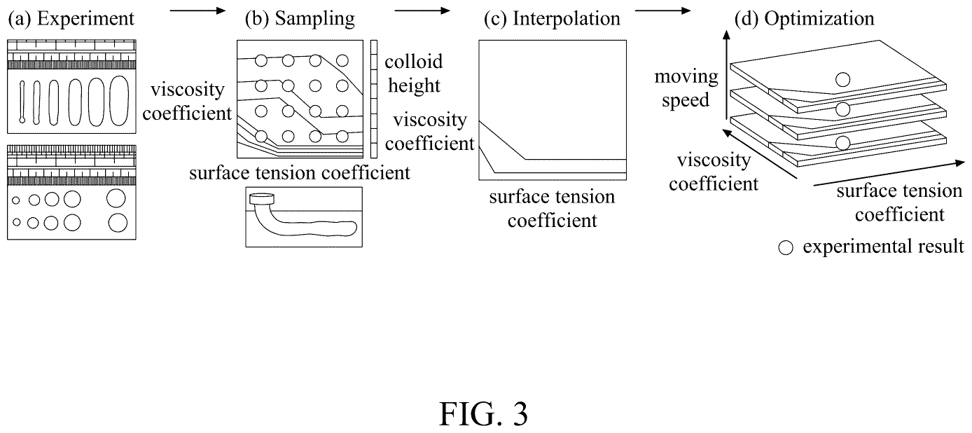

FIG. 3 is a flowchart of the method for determining colloid dispensing parameters and establishing a colloid physical model, as described in an embodiment of the present disclosure.

First, in the experimental step (a), a dispensing experiment is conducted by setting different dispensing amounts. The colloid dispensing device's robotic arm (or X-Y (-Z) positioning stage) carrying the dispensing valve system is used to perform actual dispensing or dispensing experiments.

Next, an imaging device 406 (such as a 2D or 3D camera) is used to capture the experimental results and obtain an image of the colloid. The height of the colloid is measured (using a 3D camera or laser range finder) and the width (using a 2D or 3D camera), as shown in step (a) of FIG. 3.

Proceeding to step (b), the colloid simulation is performed. Based on the experimental dispensing settings, parameters such as the moving speed of the dispensing valve, dispensing speed, dispensing height of the dispensing valve relative to a surface, and dispensing valve caliber are set (these variables are collectively referred to as ν). Different viscosity coefficients (μ) and surface tension coefficients (σ) are set, and the colloid physical simulation is conducted.

In one embodiment, the simulation process can be based on the Navier-Stokes equations and surface tension physical models, and numerical methods (such as the finite element method or finite difference method) are used to solve them, but this is not limited to these methods.

In one embodiment, the simulated colloid height (h) and simulated colloid width (w) of each simulation result are extracted, but this is not limited to these parameters.

Proceeding to step (c) of the interpolation step, a continuous function is established, i.e., the aforementioned simulation results are used with the viscosity coefficient (μ), surface tension coefficient (σ), and other known variables (ν) as inputs, and the simulated colloid height (h) or simulated colloid width (w) as outputs, to perform interpolation.

In one embodiment, the interpolation method can use linear interpolation, polynomial interpolation, or spline interpolation, but is not limited to these. In one embodiment, this allows the creation of two continuous functions, w(μ,σ,ν) and h(μ,σ,ν), which represent the simulated colloid width (w) and simulated colloid height (h), respectively, but is not limited to these.

Proceeding to step (d) of the optimization process, the simulation parameters are optimized, i.e., optimization algorithms (such as the Nelder-Mead method, L-BFGS-B (Limited-memory Broyden-Fletcher-Goldfarb-Shanno with Bounds) method, Newton-CG (Conjugate Gradient) method, Powell method, and other commonly used optimization algorithms, but not limited to these methods) are used to find the optimal viscosity coefficient μ* and surface tension coefficient σ* in order to reduce the error between the simulation results and the experimental results. Additionally, to further minimize the error between the simulation and experimental results, the disclosed residual minimization formula (Equation (1)) is applied. For different known variables v, the difference between the simulated colloid width w (or simulated colloid height h) obtained from the simulation and the experimentally measured colloid width W (or colloid height H) is subtracted, squared, and summed to obtain a value. The optimization algorithms are then used to find the optimal viscosity coefficient and surface tension coefficient that minimize this value, bringing it as close to zero as possible.

$$[ Residual Minimization Formula ]$$

$${μ}^{*} , {σ}^{*} = {min}_{μ , σ} {\sum }_{v} {( w ( μ , σ , v ) - W ( v ) )}^{2} + {( h ( μ , σ , v ) - H ( v ) )}^{2} \qquad Equation ( 1 )$$

Where μ* is the optimal viscosity coefficient (unit: kg/m*s) to be found, σ* is the optimal surface tension coefficient (unit: N/m) to be found, H(v) represents the colloid height obtained from experimental measurements under the given v, and W(v) represents the colloid width obtained from experimental measurements under the given v.

In one embodiment, the above process is not limited to the optimization of the viscosity coefficient μ and surface tension coefficient σ. For example, it can also be used to identify other optimization parameters, such as the extrusion speed (flow rate) of the dispensing nozzle (unit: m/s), extrusion time (unit: s), and nozzle size (unit: cm), and is not limited to these.

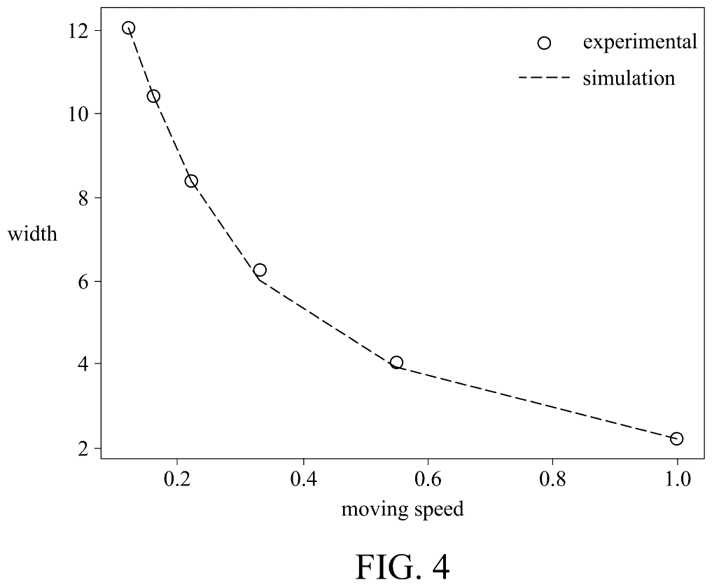

FIG. 4 is a schematic diagram illustrating the actual optimization results according to the disclosed embodiment.

FIG. 4 shows the parameter optimization results from a practical case. The Y-axis represents the colloid width, in millimeters (mm); the X-axis represents the moving speed of the dispensing valve. The dots represent colloid width data obtained from experimental measurements, while the dashed line represents the colloid width simulation results obtained using the optimized simulation parameters.

As shown in FIG. 4, the simulation results obtained using the optimized parameters match the experimental results well. This indicates that the parameter optimization method proposed in this disclosure can effectively identify appropriate simulation parameters, making the simulation results closer to the real situation.

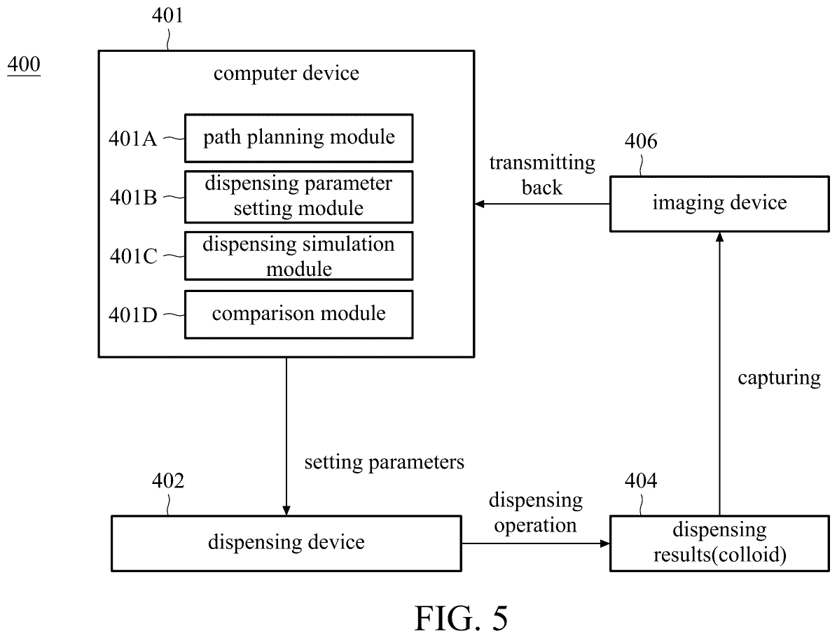

FIG. 5 is a block diagram of the colloid dispensing system 400 for dispensing according to the disclosed embodiment.

The disclosed colloid dispensing system 400 mainly includes the following components: a computer device 401, a colloid dispensing device 402, and an imaging device 406.

The computer device 401 is the core control unit of the colloid dispensing system 400, responsible for executing functions such as setting colloid dispensing parameters, simulation, comparison, and path planning. It also performs parameter adjustment and optimization based on the image information returned from the imaging device, in order to achieve optimal dispensing results.

In one embodiment, the computer device 401 may include a single processor or multiple processors. Additionally, the computer device 401 may be a single-core processor or a multi-core processor, and may also include a general-purpose microprocessor, or a combination of a general-purpose microprocessor and special-purpose processors and/or related chipsets, such as instruction-set processors, special-purpose microprocessors, and so on, but is not limited to this.

In one embodiment, the computer device 401 may also further include memory, which may include random access memory (RAM), and may also include non-volatile memory, such as one or more disk storage devices, flash memory devices, or other non-volatile solid-state memory devices, but is not limited to this.

In one embodiment, the computer device 401 includes: a path-planning module 401A, a colloid dispensing parameter-setting module 401B, a dispensing simulation module 401C, and a comparison module 401D.

In one embodiment, the path-planning module 401A is responsible for planning the movement path of the colloid dispensing system based on factors such as the shape, size, and dispensing requirements of the workpiece, ensuring that the colloid can be evenly applied to the target area.

In one embodiment, the colloid dispensing parameter-setting module 401B is responsible for setting at least one colloid dispensing parameter of the dispensing valve system. These colloid dispensing parameters include, but are not limited to, colloid width W, colloid height H, spacing D, viscosity coefficient μ, surface tension coefficient σ, the moving speed of the dispensing valve, dispensing speed, and dispensing valve height, among others.

In one embodiment, the dispensing simulation module 401C performs a colloid physical simulation, i.e., simulating the dispensing results obtained from a dispensing operation under given colloid dispensing parameters. The simulated dispensing results can include colloid width W, colloid height H, spacing D, the presence of defects, and others, but are not limited to these.

In one embodiment, the comparison module 401D compares the simulated dispensing results with the actual dispensing results 404 returned by the imaging device after performing the dispensing simulation, to assess dispensing quality and optimize parameters. In one embodiment, the colloid dispensing parameter-setting module 401B can also adjust and optimize the colloid dispensing parameters based on the comparison results from the comparison module 401D, but is not limited to this.

In one embodiment, the colloid dispensing device 402 includes components such as a robotic arm or X-Y (-Z) positioning stage and a dispensing valve system, which are used to perform the actual dispensing operation. In one embodiment, the robotic arm or X-Y (-Z) positioning stage is used to carry and move the dispensing valve system, enabling it to accurately apply the colloid to the workpiece. The dispensing valve system includes the dispensing valve, controller, and related drive mechanisms, and is used to control parameters such as the dispensing amount, dispensing speed, and path, among others, but is not limited to these.

In one embodiment, the imaging device 406, such as a 2D or 3D camera, is used to capture images of the coated colloid, acquiring information about the colloid's shape, size, position, presence of any defects, etc., and then transmitting the image information back to the computer device 401 for analysis and parameter optimization.

In one embodiment, the method for establishing a physical model of the colloid in the disclosed colloid dispensing system, carried out by the computer device 401, includes an experimental step, a sampling step, an interpolation step, and an optimization step. The experimental step includes setting at least one dispensing amount to form a colloid shape on a surface, capturing an image of the colloid shape using an imaging device, and measuring the colloid height or colloid width based on the captured image. The sampling step includes setting at least one colloid dispensing parameter and performing a colloid physical simulation based on these colloid dispensing parameters. The colloid dispensing parameters include at one or more of the following: a caliber of the dispensing valve, a moving speed of the dispensing valve, the dispensing speed of the dispensing valve, the dispensing height between the dispensing valve and the surface, the first set of multiple viscosity coefficients, and the first set of multiple surface tension coefficients. The interpolation step includes performing a colloid physical simulation based on these colloid dispensing parameters to obtain multiple simulation results, and extracting a first set of multiple colloid heights and multiple colloid widths from the simulation results. The interpolation step includes mapping the first set of viscosity coefficients and surface tension coefficients to the first set of colloid heights and colloid widths, and performing interpolation to obtain a continuous function for colloid width and a continuous function for colloid height. The optimization Step includes inputting a second set of multiple viscosity coefficients and a second set of multiple surface tension coefficients. The optimization Step includes calculating and obtaining a second set of multiple colloid widths and multiple colloid heights. The optimization Step includes using an optimization algorithm to determine the optimized viscosity coefficient and the optimized surface tension coefficient.

In one embodiment, the optimization algorithm is selected from among the following: the Nelder-Mead method, the L-BFGS-B method, the Newton-CG method, and the Powell method.

The above description and accompanying drawings fully illustrate the embodiments of the present disclosure, enabling those skilled in the art to implement them. Other embodiments may include structural, logical, electrical, procedural, and other modifications. The described embodiments represent only possible variations. Unless explicitly required, individual components and functions are optional, and the order of operations may vary. Parts and features of certain embodiments may be included in or substituted for parts and features of other embodiments. The scope of the disclosed embodiments encompasses the entire scope of the patent claims and all available equivalents thereof. The terminology used in this application is for the purpose of describing embodiments and is not intended to limit the scope of the patent claims. Additionally, as used in this application, the terms “including” and/or “comprising” refer to the presence of the stated features, components, steps, operations, elements, and/or parts, but do not exclude the presence or addition of one or more other features, components, steps, operations, elements, parts, and/or combinations thereof. Without further limitations, an element defined by the phrase “including a . . . ” does not exclude the presence of additional identical elements in the process, method, or device that includes that element. In this document, each embodiment focuses on highlighting its differences from other embodiments, while similar or identical parts among different embodiments may be referenced interchangeably. For disclosed methods, products, and other aspects of the embodiments, if they correspond to the method portion of a disclosed embodiment, the relevant parts may refer to the descriptions in the method section.

Those skilled in the art will recognize that the modules and algorithm steps described in conjunction with the disclosed embodiments can be implemented using electronic hardware or a combination of computer software and electronic hardware. Whether these functions are executed in hardware or software depends on the specific application and design constraints of the technical solution. Skilled practitioners may use different methods to implement the described functions for each specific application, but such implementations should not be considered beyond the scope of the disclosed embodiments. It will also be apparent to those skilled in the art that, for convenience and brevity, the operational processes of the aforementioned systems, devices, and modules can refer to the corresponding processes in the previously described method embodiments, and therefore, redundant descriptions are omitted.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A colloid dispensing system, comprising:
a computer device, comprising:
a colloid dispensing parameter-setting module, configured to set at least one colloid dispensing parameter; and
a dispensing simulation module, configured to perform a colloid physical simulation based on the colloid dispensing parameters to generate a simulated dispensing result;
wherein the colloid physical simulation is based on at least one of a Navier-Stokes equations and a surface tension physical model.

2. The colloid dispensing system as claimed in claim 1, wherein the colloid dispensing parameters include one or more of a viscosity coefficient, a surface tension coefficient, a moving speed, a dispensing speed, a dispensing valve height, a colloid height, and a colloid width.

3. The device as claimed in claim 1, further comprising:
a colloid dispensing device, configured to perform experimental dispensing based on the colloid dispensing parameters to generate an experimental colloid.

4. The colloid dispensing system as claimed in claim 3, further comprising:
an imaging device, configured to capture an image of the experimental colloid and transmit the image to the computer device;
wherein the computer device further includes a comparison module which compares measured results of the experimental colloid with the simulated dispensing result and detects whether there are abnormal results, and if an abnormal result is detected, the colloid dispensing parameter-setting module adjusts the colloid dispensing parameters accordingly.

5. The colloid dispensing system as claimed in claim 4, wherein the comparison module compares the image of the experimental colloid with the simulated dispensing result, detects a discrepancy between the image of the experimental colloid and the simulated dispensing result, and modifies a colloid physical simulation model based on the discrepancy to ensure that the simulated dispensing result generated by the colloid physical simulation are closer to the measured results of the experimental colloid.

6. The colloid dispensing system as claimed in claim 1, wherein the computer device further comprises a path-planning module, configured to plan a dispensing path based on the colloid dispensing parameters;
wherein the planning of the dispensing path is based on at least one of the colloid width, the colloid height, and a colloid radius in the simulated dispensing result.

7. The colloid dispensing system as claimed in claim 3, wherein the colloid dispensing device includes a robotic arm or a positioning stage, configured to carry a dispensing valve system.

8. The colloid dispensing system as claimed in claim 4, wherein the imaging device is a 2D camera or a 3D camera, configured to capture the image of the experimental colloid.

9. A colloid dispensing method, comprising:
a colloid dispensing parameter-setting step, wherein at least one colloid dispensing parameter is set; and
a simulated dispensing step, wherein a colloid physical simulation is performed based on the colloid dispensing parameters to generate a digital twin of a simulated dispensing result;
wherein the colloid physical simulation is based on at least one of a Navier-Stokes equations and a surface tension physical model.

10. A method for establishing a colloid physical model, comprising:
an experimental step, including setting at least one dispensing amount to form a colloid shape on a surface, capturing an image of the colloid shape using an imaging device, and measuring a colloid height or a colloid width based on the image;
a sampling step, including setting at least one colloid dispensing parameter and performing a colloid physical simulation based on the colloid dispensing parameters, which are at least one of the following: a caliber of a dispensing valve, a moving speed of the dispensing valve, a dispensing speed of the dispensing valve, a dispensing height between the dispensing valve and the surface, a first plurality of viscosity coefficients, and a first plurality of surface tension coefficients;
an interpolation step, including performing a colloid physical simulation to obtain multiple simulation results based on the colloid dispensing parameters, extracting a first plurality of colloid heights and a first plurality of colloid widths from the simulation results, outputting these simulation results, mapping the first plurality of viscosity coefficients and the first plurality of surface tension coefficients to the corresponding first plurality of colloid heights and the first plurality of colloid widths, and performing interpolation to derive a continuous function for the colloid width and a continuous function for the colloid height; and
an optimization step, including calculating and obtaining a second plurality of colloid widths and second plurality of colloid heights by inputting a second plurality of viscosity coefficients and a second plurality of surface tension coefficients, and using an optimization algorithm to derive an optimized viscosity coefficient and an optimized surface tension coefficient.

11. The method as claimed in claim 10, wherein the optimization algorithm is selected from at least one of the group consisting of a Nelder-Mead method, a L-BFGS-B method, a Newton-CG method, and a Powell method.

12. The method as claimed in claim 10, wherein for different known colloid dispensing parameters, a sum of the squared differences between the multiple colloid heights and colloid widths obtained from the simulation results and the colloid height or colloid width measured in the experimental step is calculated to obtain a value, wherein the optimization algorithm is then used to search for the optimized viscosity coefficient and the optimized surface tension coefficient, such that the value approaches zero.
